(19) United States
(12) Patent Application Publication
(10) Pub. No.: US 2025/0022036 A1
(43) Pub. Date: Jan. 16, 2025

(54) USER EMBEDDING GENERATION USING LLM-GENERATED CONTENT EMBEDDINGS

(71) Applicant: Maplebear Inc., San Francisco, CA (US)

(72) Inventors: Chuanwei Ruan, Sunnyvale, CA (US); Allan Stewart, Berkeley, CA (US); Li Tan, Fremont, CA (US); Yunzhi Ye, Bothell, WA (US); Aref Kashani Nejad, Redmond, WA (US)

(21) Appl. No.: 18/772,774

(22) Filed: Jul. 15, 2024

Related U.S. Application Data
(60) Provisional application No. 63/513,541, filed on Jul. 13, 2023.

(51) Int. Cl. G06Q 30/0601; G06N 3/0475; G06N 3/09

(52) U.S. Cl. CPC G06Q 30/0631; G06N 3/0475; G06N 3/09

(57) ABSTRACT

An online system selects an item to present to a user of the online system. The online system accesses user interaction data for the user. The online system transmits the user interaction data to a model serving system and receives, from the model serving system, item embeddings for the items with which the user interacted. The model serving system may use an LLM to generate the item embeddings based on the user interaction data. The online system generates a user embedding array based on the item embeddings. The online system applies a transformer network to the user embedding array to generate a user embedding describing the user. To select an item to present to the user, the online system compares the generated user embedding to item embeddings for a set of candidate items. The online system selects a candidate item based on the interaction scores.

### CROSS REFERENCE TO RELATED APPLICATIONS

This application claims the benefit of U.S. Provisional Application No. 63/513,541, filed Jul. 13, 2023, which is incorporated by reference in its entirety

### BACKGROUND

Online systems, such as online concierge systems, use embeddings to represent their users or content. By generating embeddings of users and content within the same latent space, the online systems can easily compare users or content with other users or content, which can be helpful for certain functionality performed by the online systems. Generally, online systems generate embeddings using embedding models that are trained to generate embeddings for particular uses. For example, an online system may have an embedding model that generates user embeddings based on user data and an embedding model that generates embeddings for content using content data. However, embedding models generally require structured data to be input to generate embeddings and must be trained by the online system. Thus, online systems generally must expend significant resources generating training data for embedding models, especially in cases where the user or the content has significant amounts of free text that must be converted to structured data for use in embedding models.

### SUMMARY

In accordance with one of more aspects of the disclosure, an online system uses a set of item embeddings representing items a user has interacted with to generate an embedding for the user. The online system uses a large language model (LLM) to generate these user embeddings. LLMs are trained on large amounts of text data, often involving billions of words or text units. As such, LLMs can draw nuanced connections between textual information. In generating content embeddings, an LLM may capture information beyond a title of the content. For example, an LLM may capture information embedded in the content's description, sequencing information such as what words are used first in the content title, and information about the user's interaction with the content (e.g., when did the user interact with the content, did the user search vs. view the content). In addition to drawing deep connections between textual information—advantageous for embedding generation—LLMs do not require structured data as input. Thus, the online system does not need to expend resources converting unstructured data to structured data in either the training process or inference process.

The online system accesses user interaction data for the user. The user interaction data describes user interactions for a user of the online system, where user interactions are instances in which the user performed an interaction on an item. For example, a user may interact with an item by transmitting a search query for the item to the online system or by selecting a user interface element on a user interface displayed by a client application of the online system to request additional content describing the item. The user interaction data may be unstructured data, such as free text. The online system transmits the user interaction data to a model serving system and receives, from the model serving system, item embeddings for the items with which the user interacted. The model serving system may use an LLM to generate the item embeddings based on the user interaction data, which may include information on the interaction (e.g., the user added the item to an item list) or information about the item itself, such as the item name, description, nutritional information, name, etc. The online system generates a user embedding array based on the item embeddings for the items with which the user interacted. For example, the online system may concatenate the item embeddings for the items with which the user interacted to generate the user embedding array. The online system may scale or weight each of the concatenated item embeddings based on timing information describing how recently the corresponding interaction with the item occurred. The online system applies a transformer network to the user embedding array to generate a final user embedding describing the user.

To select an item to present to the user, the online system compares the generated user embedding to item embeddings for a set of candidate items. The online system accesses the item embeddings for the set of candidate items and, for each candidate item, generates an interaction score by comparing the item embedding for the candidate item to the user embedding. The online system selects a candidate item based on the interaction scores and transmits information describing the selected candidate item to a client device associated with the user for display to the user.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 illustrates an example user embedding interaction engine 225, in accordance with one or more embodiments.

FIG. 4 illustrates an example computation of an interaction score, in accordance with one or more embodiments.

FIG. 5 is a flowchart for selecting a candidate item to present to a user, in accordance with one or more embodiments.

### DETAILED DESCRIPTION

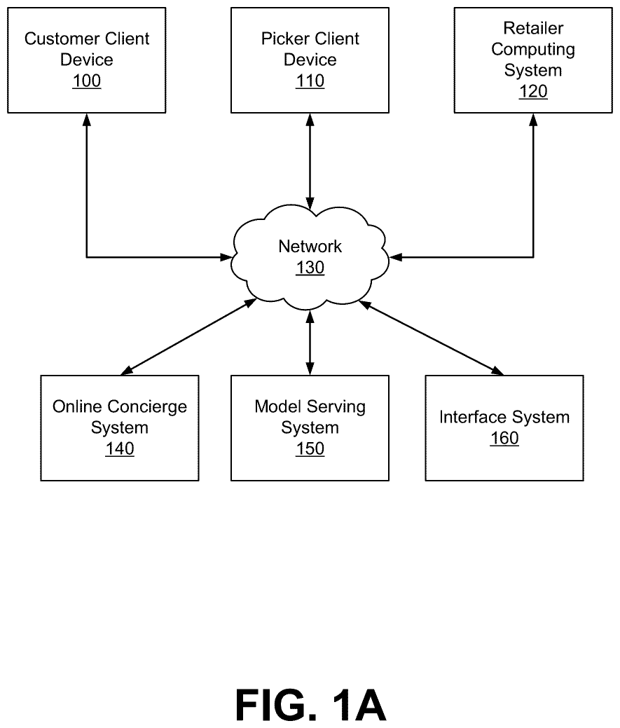

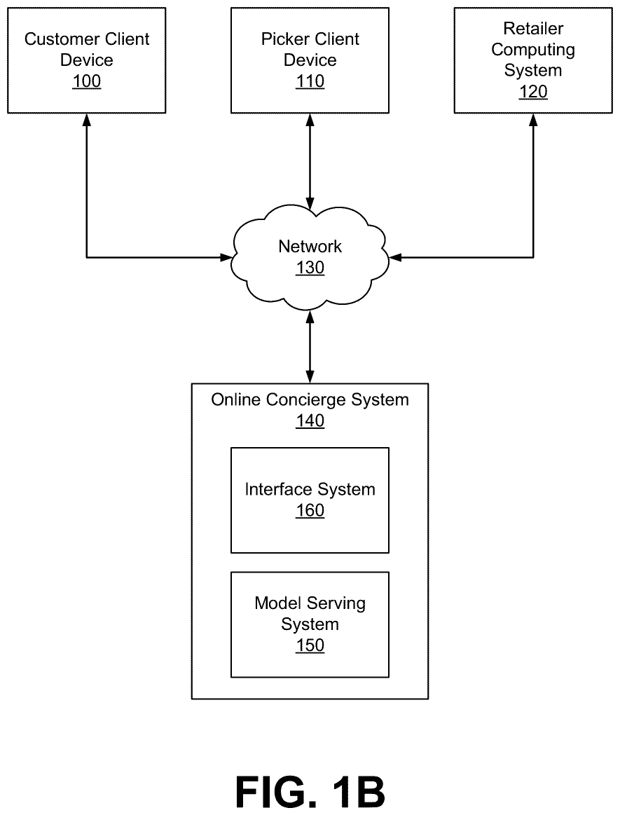

FIG. 1A illustrates an example system environment for an online concierge system 140, in accordance with one or more embodiments. The system environment illustrated in FIG. 1A includes a customer client device 100, a picker client device 110, a retailer computing system 120, a network 130, and an online concierge system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In one or more embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In one or more embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In one or more embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In one or more embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In one or more embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In one or more embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In one or more embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in one or more embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In one or more embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

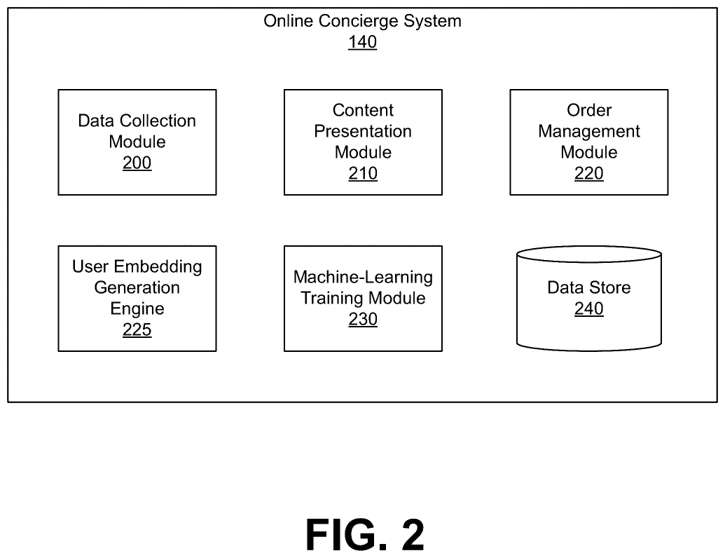

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

The model serving system 150 receives requests from the online concierge system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online concierge system 140 or one or more entities different from the online concierge system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the model serving system 150 uses an LLM to generate embeddings based on prompts. The model serving system 150 may use the LLM as an embedding model to generate embeddings based on prompts and provide those embeddings as responses to the prompts.

In one or more embodiments, the online concierge system 140 prompts the model serving system 150 to generate item embeddings using an LLM. An item embedding is an embedding that represents the item. Similar items may have similar embeddings. For example, an item “dark chocolate bar” may have a similar embedding to the item “dark chocolate chips.” The online concierge system 140 may prepare a prompt that includes item data for the item or user interaction data for interactions between one or more users and the item. Item data is information or data that identifies and describes items that are available at a retailer location. Example item data for an item may be the item's name, ID, ingredients, nutritional value, or quantity. User interaction data describes user interactions with the item. A user interaction is an instance in which a user performed an interaction on an item. For example, a user may interact with an item by searching for the item, by viewing the item, by adding the item to an item list for an order, or by placing an order that includes the item. User interaction data may include a timestamp when the interaction occurred, item data describing the item with which the user interacted, or the type of interaction that occurred. For example, if a user were to add the item “dark chocolate bar” to an item list for an order, the interaction data might describe that the user interacted with the item at 6:00 pm, that the item is 100 calories and includes ingredients “sugar” and “chocolate,” and that the user added the item to an item list. In one or more embodiments, the prompt may further include an explanation of the relative importance of each type of interaction. For example, an interaction of placing an order that includes an item may be more important than an interaction of viewing the item.

LLMs may be particularly astute at generating item embeddings. As LLMs are trained on large amounts of text data, often involving billions of words or text units, they can draw nuanced connections between textual information. An LLM may draw connections between items based on natural language used to describe the item and the connotations of that natural language. In contrast, traditional embedding models may be unable to extract such information. Traditional embedding models, such as Word2Vec, often rely heavily on word similarity. While word similarity may provide some information as to how items relate to one another, it fails to capture valuable information contained outside of an item's name or short description. For example, the items “dark chocolate” and “milk chocolate” include similar words. A traditional embedding model like Word2Vec may generate similar embeddings for these items. An LLM on the other hand may produce less similar embeddings for these items, as it may infer a difference in the items based on item name, but also based on contextual information like the nutritional information of each item (e.g., milk chocolate has more sugar than dark chocolate) or how users who prefer dark chocolate tend to dislike milk chocolate and vice versa. That is, the LLM may better be able to extract what is important about an item (e.g., the item's sweetness, chocolate-ness or darkness). Moreover, unlike a traditional embedding model, an LLM may capture sequential information. For example, an LLM may capture sequential information in the item's title. An item “protein powder, chocolate” may indicate that the item is chocolate-flavored protein powder and thus might be similar to “protein powder, vanilla.” An item with similar wording but in a different order, “chocolate powder, 5 g protein” may indicate that the item is chocolate powder containing 5 g of protein, which may be more similar to baking items such as “hot cocoa” than to protein powder.

The online concierge system 140 prepares a prompt for input to the model serving system 150. The prompt may include item data for the item or user interaction data for interactions between one or more users and the item. For example, the prompt may include a list of users who have placed an order including that item, or a list of times the item has been searched. For example, a holiday item may have user interaction data describing an increase in interactions with the item ahead of a holiday. The model serving system 150 provides the prompt to the LLM for execution and receives, as a response to the prompt, an item embedding for the item in a latent space. The item embeddings produced by the LLM are in the same latent space such that they may be easily compared.

The online concierge system 140 may store the item embedding in a data store (e.g., data store 240). In one or more embodiments, the online concierge system 140 stores a mapping between the item embedding and the item data, for example between the item embedding and the item identifier. In one or more embodiments, the online concierge system 140 stores item embeddings in CPU memory rather than GPU memory. In storing the item embeddings produced by the LLM, the online concierge system 140 avoids redundantly computing the item embeddings.

In one or more embodiments, the task for the model serving system 150 is based on knowledge of the online concierge system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online concierge system 140 is connected to an interface system 160. The interface system 160 receives external data from the online concierge system 140 and builds a structured index over the external data using, for example, another machine-learned language model or heuristics. The interface system 160 receives one or more queries from the online concierge system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online concierge system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online concierge system 140, in accordance with one or more embodiments. The system environment illustrated in FIG. 1B includes a customer client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online concierge system 140.

FIG. 2 illustrates an example system architecture for an online concierge system 140, in accordance with one or more embodiments. The system architecture illustrated in FIG. 2 includes a data collection module 200, a content presentation module 210, an order management module 220, a user embedding generation engine 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In one or more embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In one or more embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In one or more embodiments, the item selection model uses item embeddings describing items and customer embeddings describing customers to score items. These item embeddings and customer embeddings may be generated by separate machine learning models and may be stored in the data store 240.

In one or more embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In one or more embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In one or more embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In one or more embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In one or more embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In one or more embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

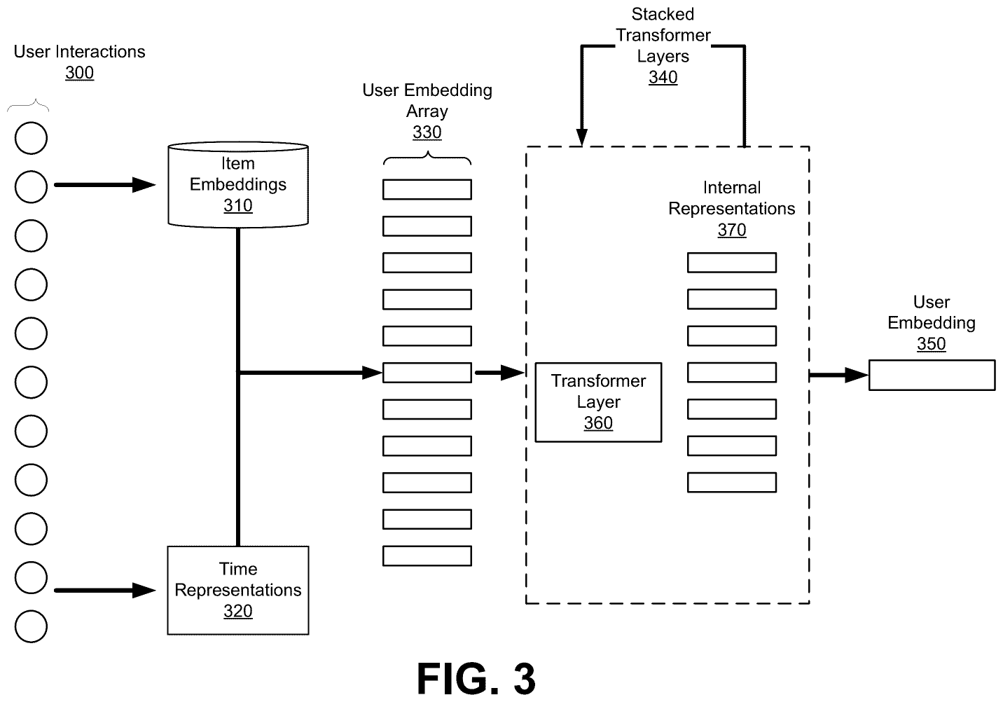

The user embedding generation engine 225 generates user embeddings based on a user's interaction history. A user's interaction history describes the user's historical interactions with items of the online concierge system. FIG. 3 illustrates an example user embedding interaction engine 225, in accordance with one or more embodiments. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

To generate a user embedding for a user, the user embedding generation engine 225 may access user interaction data for a set of user interactions 300 for the user. A user interaction is an instance in which a user performed an interaction on an item. For example, a user may interact with an item by adding the item to an item list for an order, by searching for the item, by viewing the item, or by placing an order that includes the item. Each user interaction includes a timestamp for when the interaction occurred and item data describing the item with which the user interacted. In one or more embodiments, each user interaction includes data describing the interaction, such as what type of interaction occurred (e.g., user viewed item, user added item to item list, or user placed order including item).

The user embedding generation engine 225 generates item embeddings 310 for each item of the user interactions 300. An item embedding is an embedding that represents the item. Similar items may have similar embeddings. For example, an item “dark chocolate bar” may have a similar embedding to the item “dark chocolate chips.” In one or more embodiments, the user embedding generation engine 225 generates an item embedding using an embedding model. The user embedding generation engine 225 transmits a prompt to the model serving system 150 to generate the item embeddings using the embedding model. The prompt includes the user interaction data of a user interaction 300 with an item. As described with respect to the model serving system 150, the embedding model may be an LLM. The user embedding generation engine 225 receives from the model serving system the item embeddings 310 based on the user interactions. In one or more embodiments, the user embedding generation engine 225 accesses a precomputed item embedding from a data store. The user embedding generation engine 225 accesses the precomputed item embedding based on a mapping between the item identifier and the item embedding.

The user embedding generation engine 225 also generates time representations 320 for each of the user interactions 300. Each time representation 320 is an embedding that represents the timestamp at which the interaction occurred. The timestamp may be a relative timestamp representing the difference between the time of the interaction and the time of the previous interaction or may be an absolute timestamp. The user embedding generation engine 225 may generate time representations 320 using a time embedding model, such as Mercer's time embeddings. The time representations may be in the same latent space as the item embeddings.

The user embedding generation engine 225 generates a user embedding array 330 based on the item embeddings 310 and the time representations 320. The user embedding array 330 is a set of embeddings that represent the user's past interactions with items. The embeddings in the user embedding array 330 may be the item embeddings 310 modified based on the time representations 320. For example, the user embedding generation engine 225 may compute an embedding in the user embedding array 330 by computing a vector-sum of an item embedding 310 with a corresponding time representation 320. As another example, the user embedding generation engine 225 may compute an embedding in the user embedding array 330 by concatenating an item embedding 310 with a corresponding time representation 320. In one or more embodiments, the embeddings in the user embedding array 330 are concatenated item embeddings 310 (or modified item embeddings) that correspond to a single order. For example, the user embedding generation engine 225 may group item embeddings 310 based on whether those item embeddings represent the user interactions from the same order (e.g., items that were added to the same order).

The user embedding generation engine 225 passes the user embedding array 330 through stacked transformer layers 340 that reduce the dimensionality of the user embedding array 330 to a final user embedding 350 for the user. The stacked transformer layers 340 have a set of transformer layers 360. Each of the transformer layers 360 is a transformer that generates an internal representation 370 of the user embedding array 330 as it passes through the transformer layers 360. The last transformer layer 360 in the stack generates the user embedding 350. In one or more embodiments, the transformer layers may be employed as an encoder layer. The generated user embeddings 350 may be in the same latent space as the item embeddings 310, time representations 320, or user embedding array 330. The user embedding generation engine 225 may store the generated user embeddings 350 in a data store (e.g., data store 240).

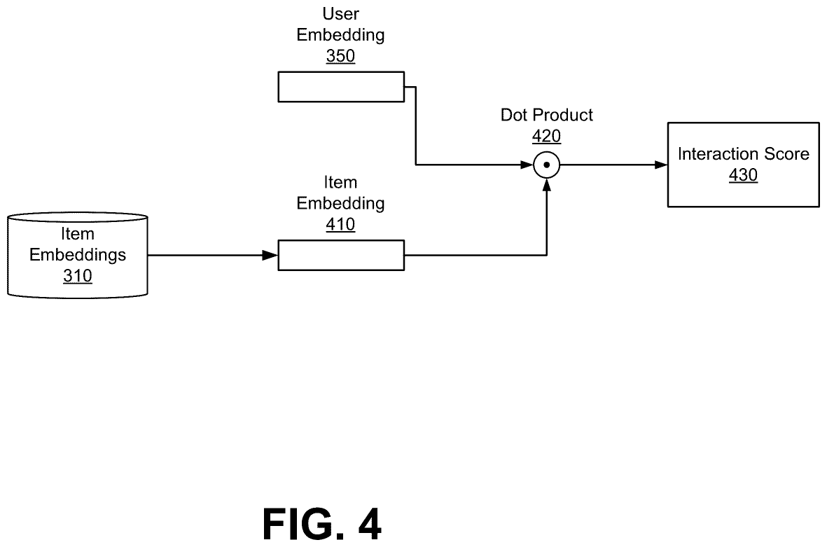

The online concierge system 140 uses a user embedding generated by the user embedding generation engine 225 to identify items with which the user is likely to interact. The online concierge system 140 may compute interaction scores for candidate items by comparing item embeddings for the candidate items with the generated user embedding. An interaction score may represent how likely the user is to interact with the candidate item. FIG. 4 illustrates an example computation of an interaction score, in accordance with one or more embodiments. The online concierge system 140 computes an interaction score 430 for a candidate item based on the user embedding 350 and an item embedding 410 for the candidate item. The user embedding 350 may be precomputed by the user embedding generation engine 225 and stored in a data store (e.g., data store 240). The online concierge system 140 may access the precomputed user embedding 350 from the data store. Similarly, the item embedding 410 may be precomputed by the model serving system 1150 using an LLM and stored in a data store. The online concierge system 140 may access the precomputed item embedding 310 from the data store. For example, the online concierge system 140 may access the precomputed item embedding based on a mapping between the item identifier of the item and the item embedding. In accessing precomputed user and item embeddings, the online concierge system 140 avoids computing the embeddings at the time of generating the interaction score. Moreover, the online concierge system 140 avoids redundantly computing item and user embeddings. In one or more embodiments, the online concierge system 140 may cache item and user embeddings such that it may access recently used item and user embeddings from a cache. The cache may store fewer embeddings than the data store, allowing the online concierge system 140 to retrieve embeddings stored in the cache faster than embeddings stored in the data store. The online concierge system 140 computes the interaction score 430 by computing a dot product of the item embedding 410 and the user embedding 350. In one or more embodiments, the online concierge system 140 computes the interaction score 410 using a binary cross-entropy loss function.

To train the stacked transformer layers, the online concierge system 140 may generate training data that has a set of training examples and train the stacked transformer layers based on the training data. Each training example includes the user interaction data for the user, an item identifier for an item with which the user interacted (or did not interact), and a label of whether the user interacted with the item. Notably, the training example includes the item identifier rather than the item embedding itself. One challenge of using pre-trained embeddings is that they significantly increase the size of the training data if the embeddings are saved. While models may be trained with up to several terabytes of data, the training process is often slow. Downloading training data, for example, may take several hours. Rather than store pre-trained item embeddings in the training data, the online concierge system stores item identifiers. When an item embedding is needed in the training process, the online concierge system 140 may access the item embedding based on a mapping between the item identifier and the item embedding. The item embeddings may be stored in CPU memory while parameters of the transformer layers may be stored in GPU memory. Returning to the training process, the online concierge system 140 generates a user embedding based on the user interaction data, as described above with respect to the user embedding generation engine 225. The online concierge system 140 compares the generated user embedding to the item embedding of the training example to generate an interaction score. The online concierge system 140 compares the interaction score to the training example's label by computing a loss score representing the difference between the interaction score and the training example's label. The online concierge system 140 uses a backpropagation process to update the stacked transformer layers based on the loss score.

The machine learning training module 230 trains machine learning models used by the online concierge system 140. For example, the machine learning module 230 may train the item selection model, the availability model, or any of the machine-learned models deployed by the model serving system 150. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online concierge system 140. In another embodiment, when the model serving system 150 is included in the online concierge system 140, the machine-learning training module 230 may further train parameters of the machine-learned model based on data specific to the online concierge system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

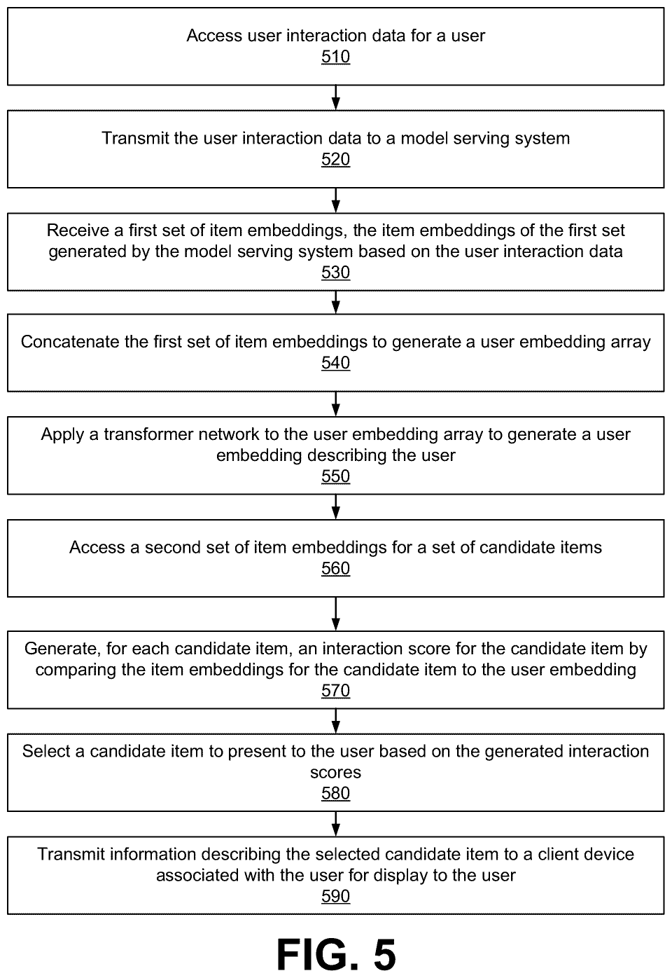

FIG. 5 is a flowchart illustrating a method of selecting a candidate item to present to a user, in accordance with one or more embodiments. Alternative embodiments may include more, fewer, or different steps from those illustrated in FIG. 5, and the steps may be performed in a different order from that illustrated in FIG. 5. These steps may be performed by any online system, for example, online concierge system 140, an online social networking system, or a video content search system. Additionally, each of these steps may be performed automatically by the online system without human intervention.

The process of FIG. 5 begins with the online concierge system 140 accessing 510 user interaction data for the user. User interaction data describes user interactions with the item. A user interaction is an instance in which a user performed an interaction on an item. For example, a user may interact with an item by searching for the item, by viewing the item, by adding the item to an item list for an order, or by placing an order that includes the item. User interaction data may include a timestamp when the interaction occurred, item data describing the item with which the user interacted, or the type of interaction that occurred.

The online concierge system 140 transmits 520 the user interaction data to the model serving system 150. The model serving system 150 receives requests from the online concierge system 140 to perform tasks using machine-learned models. The online concierge system 140 may prompt the model serving system 150 to generate item embeddings for the items with which the user has interacted. The model serving system 150 may generate item embeddings using an LLM. The prompt may include the user interaction data.

The online concierge system 140 receives 530, from the model serving system, item embeddings for the items with which the user has interacted. In one or more embodiments, the online concierge system 140 may access precomputed item embeddings. The precomputed item embeddings may be item embeddings that the model serving system 150 has previously generated using an LLM.

The online concierge system 140 concatenates 540 the item embeddings to generate a user embedding array. The user embedding array is a set of embeddings that represent the user's past interactions with items. The online concierge system 140 may generate the user embedding array by modifying the item embeddings based on time representations. Time representations are embeddings that represent the timestamp at which the interactions occurred. The online concierge system 140 may modify the item embeddings by computing vector-sums of item embeddings with corresponding time representations or by concatenating item embeddings with corresponding time representations.

The online concierge system 140 applies 550 a transformer network to the user embedding array to generate a user embedding describing the user. The online concierge system 140 passes the user embedding array through stacked transformer layers that reduce the dimensionality of the user embedding array to a final user embedding for the user. The stacked transformer layers have a set of transformer layers. Each of the transformer layers is a transformer that generates an internal representation of the user embedding array as it passes through the transformer layers. The last transformer layer in the stack generates the user embedding.

The online concierge system accesses 560 a set of embeddings for a set of candidate items and generates 570 an interaction score for each candidate item in the set. An interaction score may represent how likely the user is to interact with the candidate item. The online concierge system 140 may compute interaction scores for candidate items by comparing item embeddings with the generated user embedding. In one or more embodiments, the online concierge system 140 computes the interaction score by taking a dot product 420 of the candidate item embeddings and the generated user embedding. The online concierge system 140 may alternatively use a binary cross-entropy loss function or a cosine similarity of the embeddings to compute the interaction score.

The online concierge system 140 selects 580 a candidate item of the set of candidate items to present to the user based on the generated interaction scores. For example, the online concierge system 140 may select the candidate item with the highest interaction score, meaning that the item has the highest likelihood that the user will interact with it. The online concierge system 140 transmits 590 information describing the selected candidate item to a client device associated with the user for display to the user.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In one or more embodiments, a software module is implemented with a computer program product comprising one or more computer-readable media storing computer program code or instructions, which can be executed by a computer processor for performing any or all of the steps, operations, or processes described. In one or more embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
accessing user interaction data for a user describing a plurality of interactions by the user with a set of items of an online system, wherein the user interaction data describes, for each of the plurality of interactions, an interaction of the user with an item of the set of items;
transmitting the user interaction data to a model serving system;
receiving, from the model serving system, a first set of item embeddings, the first set of item embeddings comprising an item embedding for each item of the set of items, wherein the item embeddings of the first set of item embeddings are generated by the model serving system based on the user interaction data;
concatenating the first set of item embeddings to generate a user embedding array for the user;
applying a transformer network to the user embedding array to generate a user embedding describing the user, wherein the user embedding is in a latent space;
accessing a second set of item embeddings, the second set of item embeddings comprising an item embedding for each candidate item in a set of candidate items of the online system, wherein each item embedding of the second set of item embeddings is in the latent space;
generating, for each candidate item, an interaction score for the candidate item by comparing the item embedding for the candidate item to the user embedding;
selecting a candidate item of the set of candidate items to present to the user based on the generated interaction scores; and
transmitting information describing the selected candidate item to a client device associated with the user for display to the user.

2. The method of claim 1, wherein transmitting the user interaction data to the model serving system comprises providing a prompt to the model serving system to generate the first set of item embeddings using a large language model, wherein the prompt includes the user interaction data.

3. The method of claim 2, wherein the prompt further includes an explanation of the relative importance of each type of interaction of the plurality of interactions described by the user interaction data.

4. The method of claim 1, wherein concatenating the first set of item embeddings to generate a user embedding array for the user further comprises:
for each item embedding of the first set of item embeddings, modifying the item embedding based on a time representation, wherein the time representation is an embedding that represents a timestamp at which an interaction with the item corresponding to the item embedding occurred.

5. The method of claim 4, wherein modifying the item embedding based on the time representation comprises concatenating the item embedding with the time representation.

6. The method of claim 1, wherein comparing the item embedding for the candidate item to the user embedding comprises computing a loss function representing the difference between the item embedding for the candidate item and the user embedding.

7. The method of claim 1, wherein the first set of item embeddings include precomputed item embeddings.

8. The method of claim 7, wherein receiving, from the model serving system, the first set of item embeddings comprises accessing the precomputed item embeddings based on a mapping between item identifiers and item embeddings.

9. The method of claim 1, wherein the first set of item embeddings are stored in central processing unit (CPU) memory and wherein parameters of the transformer network are stored in graphics processing unit (GPU) memory.

10. The method of claim 1, further comprising training the transformer network based on a set of training examples, wherein each training example in the set of training examples includes user interaction data describing an interaction between a user and an item, an item identifier for the item with which the user interacted, and a label of whether the user interacted with the item.

11. A non-transitory computer-readable medium storing instructions that, when executed by a processor, cause the processor to:
access user interaction data for a user describing a plurality of interactions by the user with a set of items of an online system, wherein the user interaction data describes, for each of the plurality of interactions, an interaction of the user with an item of the set of items;
transmit the user interaction data to a model serving system;
receive, from the model serving system, a first set of item embeddings, the first set of item embeddings comprising an item embedding for each item of the set of items, wherein the item embeddings of the first set of item embeddings are generated by the model serving system based on the user interaction data;
concatenate the first set of item embeddings to generate a user embedding array;
apply a transformer network to the user embedding array to generate a user embedding describing the user, wherein the user embedding is in a latent space;
access a second set of item embeddings, the second set of item embeddings comprising an item embedding for each candidate item in a set of candidate items of the online system, wherein each item embedding of the second set of item embeddings is in the latent space;
generate, for each candidate item, an interaction score for the candidate item by comparing the item embedding for the candidate item to the user embedding;
select a candidate item of the set of candidate items to present to the user based on the generated interaction scores; and
transmit information describing the selected candidate item to a client device associated with the user for display to the user.

12. The non-transitory computer-readable medium of claim 11, wherein the instructions for transmitting the user interaction data to the model serving system comprise instructions that cause the processor to:
provide a prompt to the model serving system to generate the first set of item embeddings using a large language model, wherein the prompt includes the user interaction data.

13. The non-transitory computer-readable medium of claim 12, wherein the prompt further includes an explanation of the relative importance of each type of interaction of the plurality of interactions described by the user interaction data.

14. The non-transitory computer-readable medium of claim 11, wherein the instructions for concatenating the first set of item embeddings to generate a user embedding array further comprise instructions that cause the processor to:
for each item embedding of the first set of item embeddings, modify the item embedding based on a time representation, wherein the time representation is an embedding that represents a timestamp at which an interaction with the item corresponding to the item embedding occurred.

15. The non-transitory computer-readable medium of claim 14, wherein the instructions for modifying the item embedding based on the time representation comprise instructions that cause the processor to:
concatenate the item embedding with the time representation.

16. The non-transitory computer-readable medium of claim 11, wherein the instructions for comparing the item embedding for the candidate item to the user embedding comprise instructions that cause the processor to:
compute a loss function representing the difference between the item embedding for the candidate item and the user embedding.

17. The non-transitory computer-readable medium of claim 11, wherein the first set of item embeddings include precomputed item embeddings and wherein the instructions for receiving, from the model serving system, the first set of item embeddings comprise instructions that cause the processor to:
access the precomputed item embeddings based on a mapping between item identifiers and item embeddings.

18. The non-transitory computer-readable medium of claim 11, wherein the first set of item embeddings are stored in central processing unit (CPU) memory and wherein parameters of the transformer network are stored in graphics processing unit (GPU) memory.

19. The non-transitory computer-readable medium of claim 11, wherein the instructions further comprise instructions that cause the processor to:
train the transformer network based on a set of training examples, wherein each training example in the set of training examples includes user interaction data describing an interaction between a user and an item, an item identifier for the item with which the user interacted, and a label of whether the user interacted with the item.

20. A system comprising:
a processor; and
a non-transitory computer-readable medium storing instructions that, when executed by the processor, cause the processor to:
access user interaction data for a user describing a plurality of interactions by the user with a set of items of an online system, wherein the user interaction data describes, for each of the plurality of interactions, an interaction of the user with an item of the set of items;
transmit the user interaction data to a model serving system;
receive, from the model serving system, a first set of item embeddings, the first set of item embeddings comprising an item embedding for each item of the set of items, wherein the item embeddings of the first set of item embeddings are generated by the model serving system based on the user interaction data;
concatenate the first set of item embeddings to generate a user embedding array;
apply a transformer network to the user embedding array to generate a user embedding describing the user, wherein the user embedding is in a latent space;
access a second set of item embeddings, the second set of item embeddings comprising an item embedding for each candidate item in a set of candidate items of the online system, wherein each item embedding of the second set of item embeddings is in the latent space;
generate, for each candidate item, an interaction score for the candidate item by comparing the item embedding for the candidate item to the user embedding;
select a candidate item of the set of candidate items to present to the user based on the generated interaction scores; and
transmit information describing the selected candidate item to a client device associated with the user for display to the user.
